(19) United States
(12) Patent Application Publication
(10) Pub. No.: US 2011/0033771 A1
(43) Pub. Date: Feb. 10, 2011

(54) ELECTRODE FOR MOLTEN CARBONATE FUEL CELL AND METHOD FOR ITS PRODUCTION

(75) Inventors: Marc Bednarz, Ottobrunn (DE); Ursula Paulus-Rodatz, Landshut (DE)

Correspondence Address: RADER, FISHMAN & GRAUER PLLC, 39533 WOODWARD AVENUE, SUITE 140, BLOOMFIELD HILLS, MI, 48304-0610, US

(73) Assignee: MTU ONSITE ENERGY GMBH, Ottobrunn (DE)

(21) Appl. No.: 12/376,357

(22) PCT Filed: Aug. 1, 2007
(86) PCT No.: PCT/EP2007/006804

§ 371 Date: Nov. 1, 2010

(30) Foreign Application Priority Data
Aug. 7, 2006 (DE) 10 2006 036 849.5
Oct. 10, 2006 (DE) 10 2006 047 823.1

(51) Int. Cl. H01M 8/14; H01M 8/00

(52) U.S. Cl. 429/472; 429/535

(57) ABSTRACT

The present invention relates to an electrode for a molten carbonate fuel cell, with an electrochemically active electrode layer (10, 20), which is provided with cavities (12, 22). The invention provides that the cavities (12, 22) are surrounded and delimited by particles (13, 23) resulting from at least one imaging material. The present invention also relates to a process for producing such an electrode.

The present invention concerns an electrode for a molten carbonate fuel cell with an electrochemically active electrode layer provided with cavities, as well as a method for its production, in which a mixture containing at least one electrode material consisting of first particles for the electrode framework, at least one expanding agent and at least one binder is prepared to produce an electrochemically active electrode layer, and in which the resulting green compact is heated so that the at least one expanding agent and the at least one binder are burned off.

Fuel cells are primary elements in which a chemical reaction occurs between gas and an electrolyte. In principle, in a reversal of electrolysis of water a hydrogen-containing combustible gas is brought to an anode and an oxygen-containing cathode gas to a cathode and converted to water. The energy released is taken off as electrical power.

Molten carbonate fuel cells (MCFC) are described, for example, in DE 43 03 136 C1 and DE 195 15 457 C1. In their electrochemically active area they consist of an anode, an electrolyte matrix and a cathode. A melt of one or more alkali metal carbonates absorbed in a fine porous electrolyte matrix serves as electrolyte. The electrolyte separates the anode from the cathode and seals off the gas spaces from the anode and cathode. During operation of a molten carbonate fuel cell the cathode is supplied a gas mixture containing oxygen and carbon dioxide, generally air and carbon dioxide. The oxygen is reduced and converted to carbonate ions with the carbon dioxide, which migrated in the electrolytes. The anode is supplied hydrogen-containing combustible gas, in which the hydrogen is oxidized and converted to water and carbon dioxide with carbonate ions from the melt. The carbon dioxide is recycled in the cathode. Oxidation of the fuel and reduction of oxygen therefore occur separately from each other. The operating temperature is generally between 550° C. and 750° C. MCFC cells convert the chemical energy bound in the fuel directly and efficiently to electrical energy.

A conventional cathode consists of an electrochemically active electrode layer of nickel oxide, which is produced, for example, by so-called coating methods. A mixture of fine, powdered nickel filaments and polymer binders is then applied to a stabilizing electrode substrate, a cathode foam (for example, nickel foam). The applied amount is determined by the desired nickel weight per unit surface of the cathode. When the finished MCFC cell is started up for the first time and brought to operating temperature, the polymer binders are burned off and the metallic nickel contained both in the cathode foam and in the electrochemically active electrode layer is oxidized to nickel oxide.

Other methods for production of MCFC cathodes process a powder charge dry according to the “dry doctoring method” and a sintering process to a metallic, microporous electrode layer. These are also oxidized to a porous nickel oxide component during startup of the MCFC, but in which no binder is burned off.

The cathode reaction occurring during operation of the MCFC cell, in which oxygen is reduced and converted to carbonate ions with carbon dioxide, which migrate into the electrolyte, is a very complex process, since the three phases electrode, cathode gas and electrolyte participate in it. The morphology of the cathode is therefore an essential factor for optimal cathode reaction. One aspect of the morphology of the cathode is the porosity of the electrochemically active cathode layer. In principle, this porosity is the result of burn-off of the binder, in which cavities remain, which ultimately depends on the type of particles used for the initial material. In a case in which powdered nickel filaments and a binder are used as starting material for production, there is no possibility of actively controlling the size and distribution of the forming pores.

A bimodal pore distribution is generally sought, in which pores with two different pore sizes exist next to each other in the electrochemically active cathode layer. During operation the larger pores (subsequently called gas transport pores) serve for gas transport within the electrode, whereas the electrochemical reaction occurs in the smaller pores filled with molten electrolyte (subsequently called reaction pores).

Methods are known in the prior art with which the size and distribution of the forming pores are to be actively controlled. DE 1 907 326 A1 describes a method in which a expanding agent, which volatilizes during sintering, is ground in a ball mill to a particle size of approx. 5 μm to 25 μm to produce an electrode material and nickel powder then immediately mixed into the ball mill. A uniformly fine pore structure is supposed to be achieved in the finished electrolyte on this account. U.S. Pat. No. 4,410,607 discloses a method for production of an electrode with a bimodal pore distribution, i.e., with a distribution of small and large pores in which fine nickel oxide is mixed with a binder and then ground to large agglomerated particles.

Common to these methods is that both the size and distribution of the pores cannot be directly influenced by the choice of starting materials, especially the choice of particles for the electrode material, but only indirectly, i.e., a corresponding pore spectrum is automatically set as a function of the chosen starting material. The size of the particles of the electrode starting material, however, cannot be freely chosen with respect to power. The power of the electrodes known in the prior art is the limiting factor for the power density of the overall system of the MCFC cell and the power of electrodes again depends primarily on their pore spectrum, i.e., the size and distribution of the individual pores. The lifetime of an MCFC cell is also decidedly influenced by the introduced amount of electrolyte, which also depends on the size and number of reaction pores. The amount of electrolyte that can be introduced to the microporous electrodes without a power loss is strongly dependent on the size and distribution of the pores and the MCFC electrodes.

The task of the present invention therefore consists of preparing an electrode of the aforementioned type whose pore spectrum is optimized with respect to power density and lifetime of the MCFC cells. The task of the present invention is also to propose a method for production of such an electrode.

The solution consists of an electrode with the features of claim 1 and a method with the features of claim 10. It is proposed according to the invention that the electrode additionally contain at least one imaging material in the form of second particles that delimit the cavities that represent the image of an expanding agent originally situated at the location of the cavities. The method according to the invention is characterized by the fact that at least one imaging material in the form of second particles or a material that produces a second particle during drying or heating of the mixture is additionally introduced to the mixture, in an amount and size so that the imaging material covers at least most of the expanding agent and that bounded cavities remain after burn-off of the imaging material.

In addition to electrode material and expanding agent, a so-called imaging material is therefore introduced to the mixture to produce an electrode. The imaging material serves to coat the particles of the expanding agent in the mixture at least for the most part. After burn-off of the expanding agent a “negative mold” of the coated particle remains, i.e., a cavity enclosed by imaging material which serves as gas transport pores or reaction pores.

The electrode according to the invention and the method according to the invention make it possible to influence the pore spectrum actively and directly by the method according to the invention so that the pore spectrum can be optimized in deliberate and controllable fashion regardless of the size of the first particles of the electrode starting material with respect to power density and a lifetime of an MCFC cell. In particular, reaction pores can be prepared which are smaller than would be possible by choosing the starting material for the first particles. The power of the electrode according to the invention with optimized pore spectrum is significantly increased relative to the prior art, since the polarization resistance is significantly reduced. The tolerance for higher electrolyte filling without adversely affect the power is significantly increased so that the lifetime is significantly increased. The increase in power density and lifetime of an MCFC cell equipped with electrodes according to the invention directly leads to significant cost saving both with respect to the cell stack and the entire fuel cell system.

Advantageous modifications are apparent from the dependent claims.

The electrode according to the invention has a pore spectrum having an accumulation of expanding agent imaged by the second particles as pores.

The second particles that represent the imaging material delimit cavities that serve as gas transport pores and/or reaction pores.

Substances that burn off free of residue at the latest on reaching the operating temperature of the MCFC fuel cell (approx. 600° C. to 650° C.) are preferably chosen as expanding agent for the (larger) gas transport pores. Such expanding agents are known to one skilled in the art. Possible expanding agents include different types of fibers, in which both branched fibers and unbranched fibers can be used. The diameter of the fibers can lie between 5 μm and 50 μm, the range from 5 μm to 20 μm being preferred. The length of the fibers can be 10 μm to 50 μm, preferably 100 μm to 200 μm. Appropriate fibers include polyethylene fibers, cellulose fibers, carbon fibers of any type, fibers from carbonized polyacrylonitrite, fibers based on nylon, silk fibers and any comparable type of fiber.

Substances that burn off free residue at the latest on reaching the operating temperature of the MCFC fuel cell (approx. 600° C. to 650° C.) are preferably also chosen as expanding agent for the (smaller) reaction pores. Such expanding agents are known to one skilled in the art. Expanding agents that have a spherical or irregular form are preferred. The diameter of the expanding agent can lie between 1 μm and 5 μm, a value of 3 μm being preferred. The diameter of the expanding agent is understood to mean the average diameter of a solid imagined to enclose the core particle. Without claiming completeness, the following substances are conceivable as expanding agents for electrolyte-filled reaction pores: graphite powders and dusts, carbon black powders and dusts, carbon powders and dusts, salts that dissolve in the electrolyte or serve as electrolyte, resin emulsions, wax emulsions, organic pigments as well as any type of sugar compounds and starches.

The so-called imaging material, which includes the second particles, serves to enclose at least for the most part the particles of the expanding agents. When the expanding agents are burned off without residue, the imaging material remains behind and encloses a cavity that was filled beforehand with the corresponding particle. In other words: the pore formed by the expanding agent is imaged in the starting material by the imaging material. This means that the pore, i.e., the cavity enclosed by the imaging material has a diameter that corresponds to the diameter of the particle of expanding agent present beforehand. Pores of defined size and defined amount that produce optimal power can therefore be generated. In particular, pores that do not depend on the type of first particle can be generated, which form the electrode framework (which are obtained from the filament powder).

Particles that naturally (or after burn-off of the expanding agent) have a spherical, cubic or irregular form and advantageously a particle diameter to 3 μm, preferably less than 1 μm, are suitable as imaging material. Particle diameter is understood to mean the average diameter of a solid imagined to enclose the naturally irregular particle. Metal powders, metal oxide powders, metal oxide hydrates as well as inorganic or organic metal salts are particularly suitable. Examples include pyrolyzable nickel compounds, like nickel salts, preferably nickel nitrate or nickel acetate, which form corresponding particles during drying or heating. In-situ generation of the nickel salt by addition of acid (for example, acetic acid or nitric acid) to a nickel-containing mixture, for example, to a nickel-containing slip, is also possible. Fine or ultrafine nickel oxide powder is also suitable as imaging material. Finally, nickel oxide hydrate preparations, which can be obtained in known fashion by precipitation from nickel-containing solutions, are also suitable. The imaging material can also consist of a material for the electrode framework (i.e., the active electrode layer), but smaller in terms of particle size, in the form of a preferably fine or ultrafine powder.

The ratio of nickel (total amount) expanding agent preferably varies in a range from 1:1 to 10:1 by weight. In particular, nickel oxide powders suitable as imaging material have spherical or cubic particles with a defined size so that this calculation is simple to perform. The weight fraction of the necessary imaging material then generally varies in the range from 3 to 15 wt % referred to the total amount of mixture being produced. The amount of imaging material can preferably be chosen so that at least almost complete enclosure of the particles of the expanding agent is possible.

The amount of imaging material is determined by the dimensions of the (first) particles of the employed imaging material and the dimensions of the expanding agent. For each type of imaging material this dimension follows a certain statistical distribution so that the necessary amount of imaging material (depending on the dimension of the particles and the size of the surface being coated) can be properly determined according to experience. This means that sufficiently many second particles are also present in homogeneous distribution so that almost complete covering of the particles of the expanding agent is possible. However, it is actually assumed that the amount of addition is not merely dictated by the statistical distribution of particles but that adhesion forces also play a role. Particles contained in the suspension have a tendency to form agglomerates simply because small particles because of molecular attraction forces add to each other to form larger particles. For deliberate control of addition the expanding agent and the imaging material, which can be present in particle form or as a solution, are mixed with each other before processing with additional materials in the electrode slip. If a solution is present, appropriate particles are formed during drying or heating of the green compact.

The electrode material, the expanding agent and the imaging material can be processed together to an electrode slip in a manner known to one skilled in the art. As mentioned, the expanding agent and the imaging material, however, can advantageously be mixed with each other beforehand, since covering of the expanding agent with the imaging material is then simplified.

The present invention is not restricted to aqueous systems, but can also be applied to alcoholic systems, in which case nickel salts are not used as imaging material but nickel oxide particles.

The present invention is also not restricted to electrodes that are produced from a nickel slip system. It is also suitable for electrodes produced by powder compression (so-called “dry doctoring” systems). In this case the expanding agent, before introduction to the dry powder mixture, is covered with the imaging material, for example, in a preceding impregnation or mixing step or the like.

Practical examples of the present invention are further described below with reference to the accompanying drawing. In a schematic depiction not true to scale:

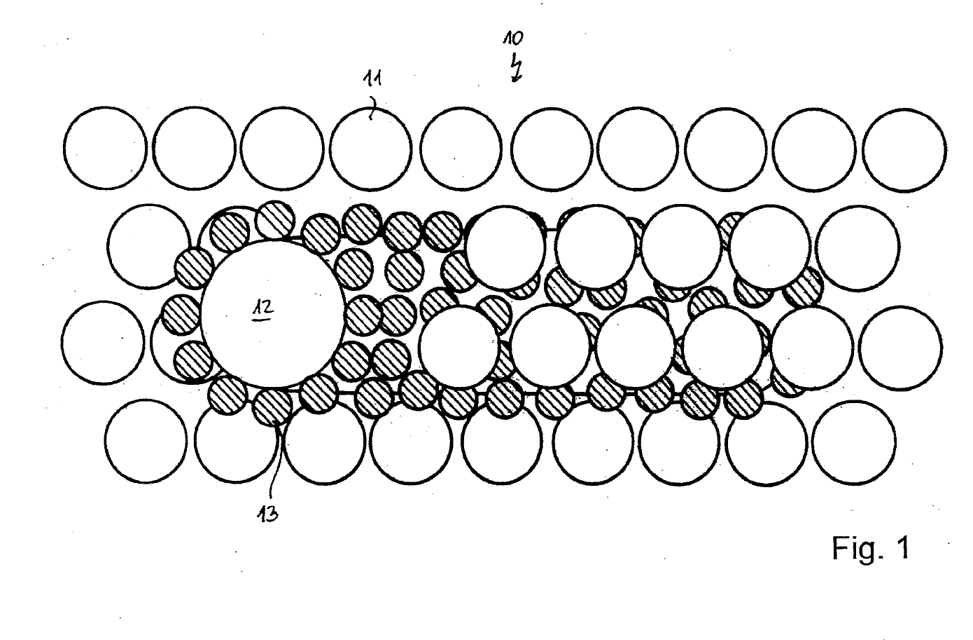

FIG. 1 shows a view of a gas transport pore in an electrode according to the invention;

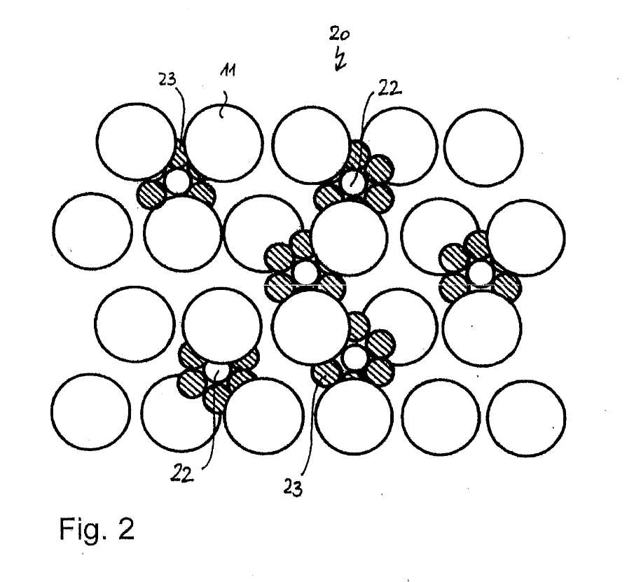

FIG. 2 shows a view of a reaction pores in an electrode according to the invention;

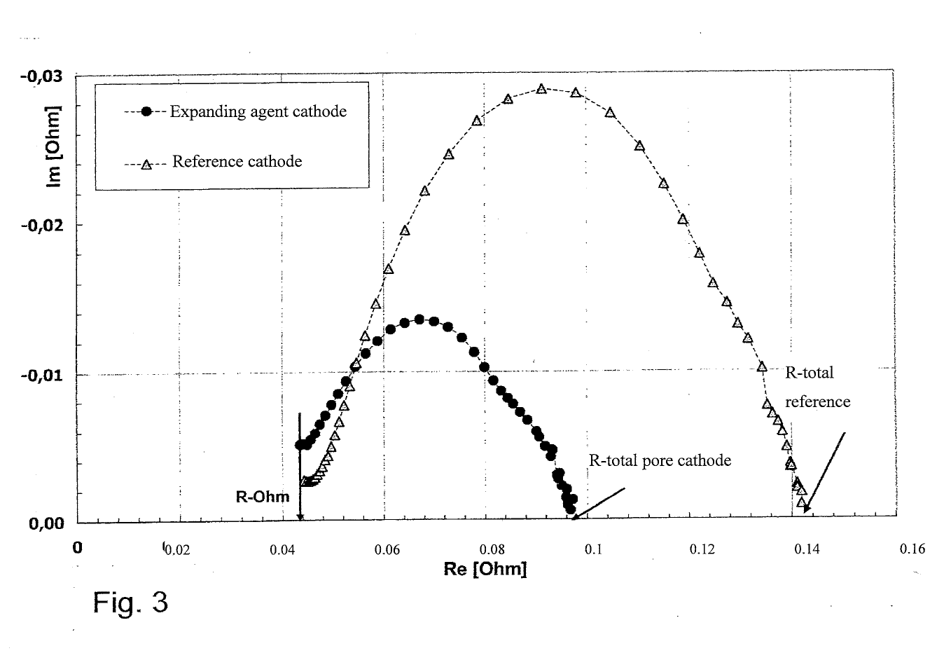

FIG. 3 shows the impedance spectrum of the first variant of an electrode according to the invention as well as a reference electrode;

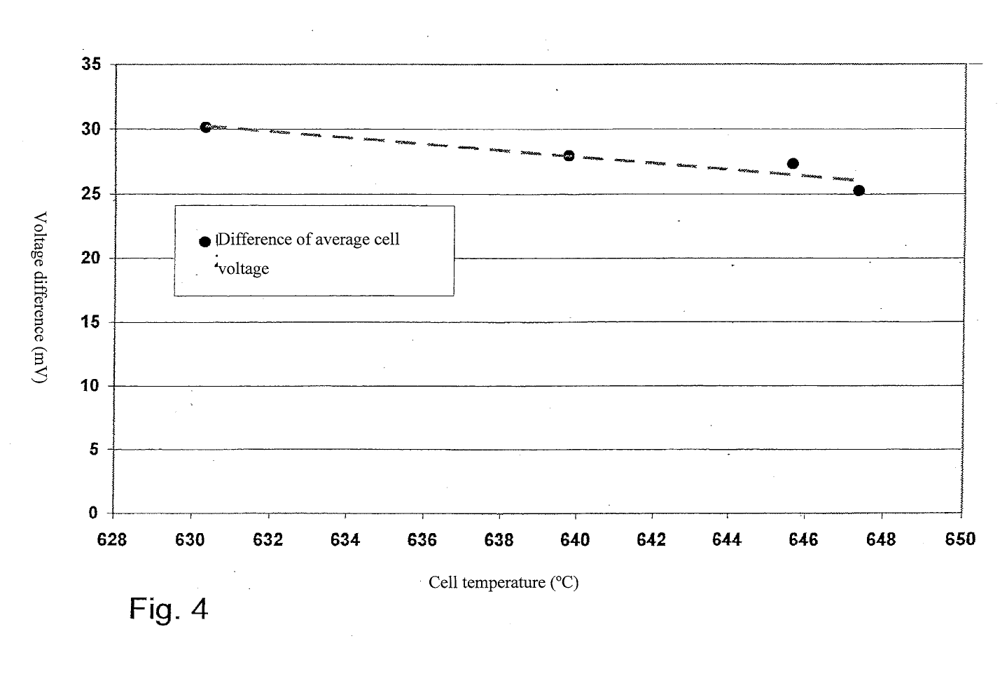

FIG. 4 shows a graphic view of the voltage differences in laboratory stacks between cells with electrodes according to the invention and cells with reference electrodes;

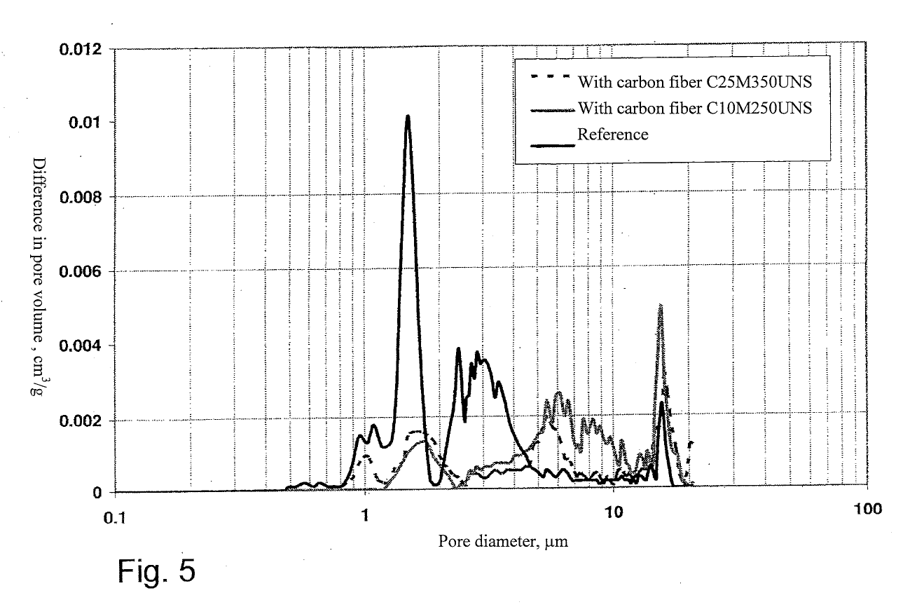

FIG. 5 shows a pore spectrum of an electrode according to the invention as well as a reference electrode;

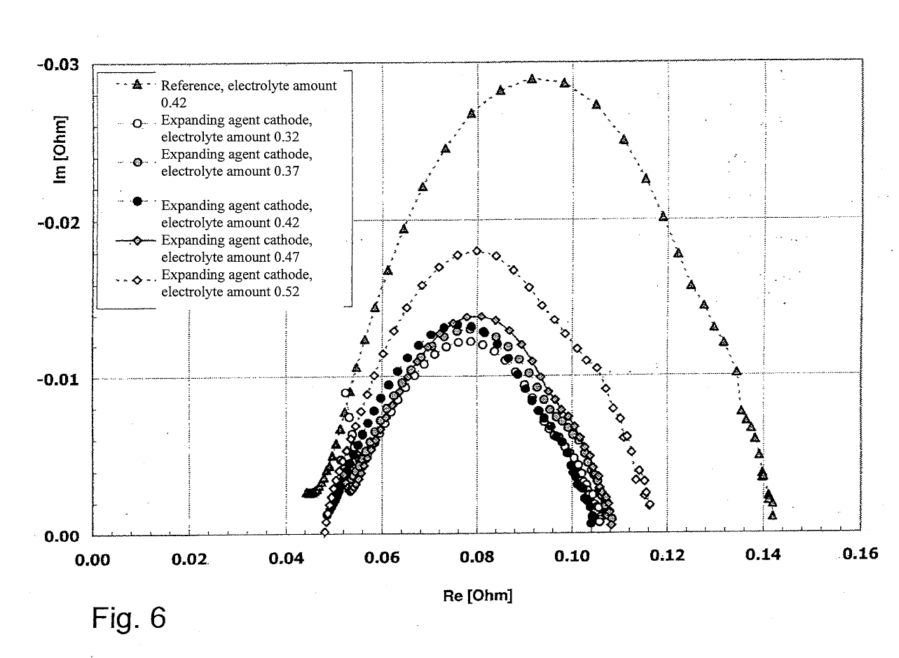

FIG. 6 shows the impedance spectrum of a second electrode according to the invention with different amounts of electrolyte and a reference electrode with a standard amount of electrolyte.

A practical example of an electrode according to the invention based on nickel can be prepared as follows:

In principle, all nickel powders known to one skilled in the art are suitable as starting material (first particle). Filament-like nickel powders are preferably used, for example, the nickel powders known under the designation Ni-210, Ni-240, Ni-255 or Ni-287.

A typical formula for an electrode with gas transport pores appears as follows:

| | |
|---|---|
| Nickel powder (Ni-210 filament powder) | 30-50 wt % |
| Expanding agent (fiber material, carbonized polyacrylonitrite, | 5-10 wt % |
| diameter about 5 μm, length about 100 μm) | |
| Imaging material nickel acetate tetrahydrate | 3-15 wt % |
| Water | 10-20 wt % |
| Organic binder (moviol, glycerol, agitan) | remainder |

The fiber material and the nickel acetate tetrahydrate are intimately mixed with each other and the resulting mixture processed with the remaining components in known fashion to an electrode slip. The electrode slip is applied to a substrate, for example, an electrode substrate (nickel foam) and dried. The applied amount is determined by the desired nickel weight per unit surface. The resulting green compacts are processed in known fashion to a cathode for MCFC fuel cells. During startup of the fuel cells the organic binder and the pore forming material are burned off and the nickel of the nickel foam and the electrochemically active layer oxidized to nickel oxide. The nickel acetate tetrahydrate is converted to nickel oxide.

FIGS. 1 and 2 show as examples the structure of electrodes resulting from the described method. FIG. 1 shows an electrochemically active layer 10 with first particles, namely nickel oxide particles 11. An elongated cavity 12 is originally formed by the materials suitable as expanding agents (here fibers) and bounded by the second particles, namely ultrafine nickel oxide particles 13, and serves as gas transport pores. The first particles 11 are larger than the second particles. This type of structure forms, for example, with the aforementioned formula.

FIG. 2 shows in comparable fashion and electrochemically active layer 20 with (first) nickel oxide particles 11. Numerous spherical cavities 22 are bounded by ultrafine (second) nickel oxide particles 23 and serve as reaction pores. Production occurs according to the formula mentioned above, in which the aforementioned expanding agent is replaced by a expanding agent suitable for production of the reaction pores. It is conspicuous that the diameter of the cavity 22 is smaller than the cavity formed by the first nickel oxide particles 11, which represent the electrode framework. Such a structure cannot be produced with the method known in prior art.

The aforementioned formula can naturally simultaneously contain expanding agents both for production of gas transport pores and production of reaction pores. An electrochemically active layer with a bimodal structure/pore distribution then forms, i.e., pores of different size whose size and distribution can be actively and directly influenced in the electrochemically active layer by selection of the expanding agents material and their coating with the imaging material. The ratio of number of pores of different type can be controlled by the amount ratio of the employed expanding agents.

Cathodes according to the invention produced according to the above method (subsequently expanding agent cathodes) with deliberately introduced gas transport pores (cf. FIG. 1) were investigated in comparison with the standard cathodes produced with the usual method (subsequently reference cathodes). FIG. 3 shows the impedance spectrum (Nyquist plot) of a expanding agent cathode (black circles) and a reference cathode (gray triangles) in a half cell measurement in which the electrodes were filled with a standard electrolyte amount of 0.42 times the amount of applied nickel. The impedance spectra were obtained during measurements in a cathode half-cell test bench (cf. “Mechanistic Investigation and Modeling of Cathode Reaction in Carbonate Fuel Cells (MCFC)”, M. Bednarz, dissertation, Hamburg University, 2002). Two identical cathodes (in one case as working electrode and in one case as counterelectrode) were used per half-cell test. The cathode test specimens the each had a surface of 9 cm². It is readily apparent that with almost identical ohmic resistance (R-ohm) of 45-50 mΩ for the expanding agent cathode and for the reference electrode the total resistance (R-total) for the expanding agent cathode at about 100 mΩ is much lower that the total resistance for the reference electrode at about 140 mΩ. The expanding agent cathode is therefore superior to the reference electrode.

The transferability of the half-cell test to the full cell was demonstrated by means of laboratory stack experiments. To represent the power capability of the expanding agent cathodes and to permit a direct comparison, a laboratory stack was equipped both with expanding agent cathodes (group 1) and reference cathodes (group 2). FIG. 4 shows the difference in average cell voltage of these two cell groups at different cell temperatures between 630° C. and 648° C. The cells with expanding agent cathodes in all cases show a better power than the cells with reference cathodes. The cell voltage difference varies with a current density of 120 mA/cm² between 25 mV and 30 mV. It should be noted that the cell voltage difference increases with diminishing temperature. This means that the superiority of the expanding agent cathode during a reduction in cell temperatures emerges more distinctly. A reduction of cell temperatures is accompanied by lengthened stack lifetimes. The cells with expanding agent cathodes therefore show a better power with increased lifetime than the cells with the reference cathodes.

FIG. 5 shows the pore spectra for a reference electrode (black, solid) and two electrodes with expanding agents, once with the carbon fiber C10M250UNS (gray) and once with the carbon fiber C25M350UNS (black, dashed). The expanding agent cathodes were also produced with the aforementioned formula. All three cathodes were measured in the burned-off state, i.e., after residue-free burning off of the carbon fibers. It is apparent that in the reference cathode pores with a diameter of 1 μm to 3 μm are mostly present. In the two expanding agent cathodes a percentage of smaller pores with a diameter of about 2 μm are also present but in smaller percentage than in the reference cathode. However, larger pores with diameters in the range from 5 μm to 10 μm are also present.

FIG. 6 shows the impedance spectrum (Nyquist plot) of a expanding agent cathode (circles and diamond symbols) and a reference cathode (gray triangles) in a half-cell measurement as already described for FIG. 3. The expanding agent cathode was filled with different electrolyte amounts from 0.32 to 0.52 times the applied amount of nickel. The reference cathode is filled with a standard electrolyte amount of 0.42 times the applied amount of nickel. The impedance spectra were obtained during measurement to the cathode half-cell test bench (cf. description for FIG. 3). Two identical cathodes (once as working cathode and once as counterelectrode) were used for the half-cell test. All tested cathodes have very similar ohmic resistances in the range from 45 mΩ to 50 mΩ. A slight in ohmic resistance to higher values is then common with increasing electrolyte filling. However, it is apparent that the expanding agent cathode itself at high electrolyte fillings (total resistance of about 115 mΩ for the 0.52 filling) shows lower total resistances than the reference cathode, which has R-total of about 140 mΩ. With reference to filling tolerance at higher electrolyte fillings and, as a result, with reference to lifetime, the expanding agent cathode therefore comes out superior.

1. An electrode for a molten carbonate fuel cell, with an electrochemically active electrode layer (10, 20) provided with cavities (12, 22), which contains an electrode material consisting of first particles (11), characterized by the fact that the electrode additionally contains at least one imaging material in the form of second particles (13, 23), which delimit the cavities (12, 22), which represent the image of a expanding agent originally situated at the location of the cavities (12, 22) before burn-off.

2. An electrode according to claim 1, characterized by the fact that the pore spectrum of the electrode has an accumulation of pores of the expanding agent imaged by the second particles (13, 23).

3. An electrode according to claim 1, characterized by the fact that the second particles (13, 23) representing the imaging material delimit cavities (12, 22) that serve as gas transport pores and/or reaction pores.

4. An electrode according to claim 1, characterized by the fact that cavities (12) serving as gas transport pores with a diameter from 5 μm to 50 μm, preferably 5 μm to 20 μm are present.

5. An electrode according to claim 1, characterized by the fact that cavities with a length of 10 μm to 500 μm, preferably 100 μm to 200 μm are present in the gas transport pores (12).

6. An electrode according to claim 1, characterized by the fact that cavities (22) with a diameter of up to 5 μm, preferably 1 μm to 3 μm, are present as reaction pores.

7. An electrode according to claim 1, characterized by the fact that the second particles (13, 23) consisting of at least one imaging material have a spherical, cubic or irregular form with a diameter of up to 3 μm, preferably less than 1 μm.

8. An electrode according to claim 1, characterized by the fact that the electrode layer (10, 20) is applied to an electrode substrate, which is a nickel-continuing framework.

9. An electrode according to claim 1, characterized by the fact that the imaging material consists of metal-containing particles, preferably nickel-containing particles.

10. A method for production of an electrode for a molten carbonate fuel cell, in which a mixture is prepared for production of an electrochemically active electrode layer (10, 20), which contains at least one electrode material consisting of first particles (11), at least one expanding agent and at least one binder, and in which the resulting green compact is heated so that the at least one expanding agent and the at least one binder are burned off, characterized by the fact that in the mixture before burn-off at least one imaging material in the form of second particles (13, 23) or in the form of a material that yields second particles (13, 23) during drying or heating is introduced, specifically in an amount and the particles (13, 23) in a size so that the imaging material (13, 23) covers the expanding agent at least for the most part and that after burn-off cavities (12, 22) delimited by the imaging material remain.

11. A method according to claim 10, characterized by the fact that the second particles (13, 23) in the green compact are smaller than the first particles (11) and smaller than the particles of the expanding agent.

12. A method according to claim 10, characterized by the fact that the green compact before heating is applied to an electrode substrate and a metal foam, preferably nickel foam, is used as electrode substrate.

13. A method according to claim 10, characterized by the fact that substances that burn off free residue at the latest at temperatures from 600° C. to 650° C. are used as expanding agent.

14. A method according to claim 10, characterized by the fact that branched or unbranched fibers are chosen as expanding agent, which have a diameter from 5 μm to 50 μm, preferably 5 μm to 20 μm and/or a length from 10 μm to 500 μm, preferably 100 μm to 200 μm.

15. A method according to claim 10, characterized by the fact that particles with a spherical or irregular shape are chosen as expanding agents, which have a diameter from 1 μm to 5 μm, preferably 3 μm.

16. A method according to claim 10, characterized by the fact that particles with a spherical, cubic or irregular form are chosen as imaging material, which especially have a diameter of up to 3 μm, preferably less than 1 μm.

17. A method according to claim 10, characterized by the fact that the first particles (11) have a size of 10 μm to 40 μm.

18. A method according to claim 10, characterized by the fact that metal powders, metal oxide powders, metal oxide hydrates, inorganic or organic metal salts are used as imaging material.

19. A method according to claim 18, characterized by the fact that pyrolyzable nickel compounds are used as imaging material.

20. A method according to claim 19, characterized by the fact that pyrolyzable nickel salts, preferably nickel nitrate or nickel acetate, are used.

21. A method according to claim 20, characterized by the fact that the nickel salts are produced in-situ by addition of acid, preferably acetic acid or nitric acid, to the nickel-containing mixture.

22. A method according to claim 18, characterized by the fact that fine or ultrafine metal oxide powder, especially nickel oxide powders, are used.

23. A method according to claim 10, characterized by the fact that the imaging material is added in a fraction of 3 to 30 wt % referred to the total amount of the mixture.

24. A method according to claim 10, characterized by the fact that the expanding agent and the imaging material are initially mixed with each other and then processed to a mixture with the at least one electrode material and the at least one binder.

25. A method according to one of claim 10, characterized by the fact that the mixture is produced as an electrode slip or from the powder mixture.

26. A method according to claim 10, characterized by the fact that the mixture is produced as an aqueous or alcoholic system.
